(19) United States
(12) Patent Application Publication
(10) Pub. No.: US 2024/0116818 A1
(43) Pub. Date: Apr. 11, 2024

(54) CASTING COMPOUNDS, COMPOSITE MATERIAL AND CHANNEL SYSTEMS WITH STABILIZING CASTING COMPOUND

(71) Applicant: SCHOTT AG, Mainz (DE)

(72) Inventors: Frank Jürgen Druschke, Mainz (DE); Ralf-Dieter Werner, Mainz (DE); Christian Kunert, Mainz (DE); Peter Franke, Mainz (DE); Manfred-Josef Borens, Mainz (DE); Franz-Peter Eckes, Bubenheim (DE)

(73) Assignee: SCHOTT AG, Mainz (DE)

(21) Appl. No.: 18/479,175

(22) Filed: Oct. 2, 2023

(30) Foreign Application Priority Data
Sep. 30, 2022 (DE) 10 2022 125 252.3

(51) Int. Cl. C04B 35/14; C04B 35/64

(52) U.S. Cl. CPC C04B 35/14; C04B 35/64; C04B 2235/3418; C04B 2235/365; C04B 2235/5427; C04B 2235/5436; C04B 2235/5481; C04B 2235/6027; C04B 2235/9669

(57) ABSTRACT

A formulation for a casting compound is provided that includes a base slip with a proportion between 18% and 36% by weight, quartz glass particles with a proportion between 40% and 70% by weight, and particles of an admixture having at least one multicomponent glass with a proportion between 10% and 40% by weight. The base slip contains water as dispersion medium with a content between 30% and 50% by weight and ultrafine Si0 2 particles colloidally distributed therein with a content between 50% and 70% by weight, and wherein the total water content in the formulation is 10% to 20% by weight. A composite material is also provided that has a largely crystalline Si0 2 matrix and particles of a multicomponent glass embedded therein.

### CROSS REFERENCE TO RELATED APPLICATIONS

This application claims benefit under 35 USC §119 of German Application 10 2022 125 252.3 filed Sep. 30, 2022, the entire contents of which are incorporated herein by reference.

### BACKGROUND

### 1. Field of the invention

In general, the invention relates to casting compound and to composite materials producible therefrom, and also to channel systems with stabilizing casting compounds. Specifically, the invention relates to casting compounds and composite materials, especially for production of channel systems for glass melts.

### 2. Description of Related Art

In glass production, transportation of the liquid glass from the melt tank or the melt crucible requires refractory channel systems. In addition, the glass is further conditioned for further processing in the channel systems. For example, it is thus possible to adjust the processing temperature by heating or cooling processes or to further homogenize the glass. The operating temperatures here are in the range from 800° C. to 1700° C. In addition, the glass melt comes into direct contact with the channel systems. This results in the need for the channel materials used to be inert or at least largely inert with respect to the glass melt and also to the high operating temperatures. The channel systems known from the prior art are manufactured from special metallic alloys, for example platinum alloys, or ceramic systems. Ceramic systems or materials in such channel systems, especially also in conjunction with metals, consist here, for example, of purely ceramic materials, for instance aluminium oxide and/or zirconium oxide, and additionally also comprise purely quartz- or SiO₂-based materials, for example what is called fused silica or quartzware.

Since the mechanical durability of metallic components is only very low at the high operating temperatures, channel systems with metal channels additionally have supporting structures. A multitude of different demands are placed on the structures here. For instance, the material of the external structure has to be chosen such that the expansions of the metal channels that occur as a result of the relatively high coefficients of thermal expansion of the metals used are compensated for or balanced out by the external structure. Moreover, the external structure in the case of damage to the channels and hence arising leakage should prevent the escape of glass and thus shall enable further production at least with minimum time limitation using the channel system.

The external structure also fulfils a function that goes beyond the stabilization of the metal channel, in which the necessary technical components, for example temperature measurement technology and heating technology, are accommodated within the external structure.

A further demand on the external structure is that of a simple and flexible construction directly at the site of use, for example at the glass melting plant. Ideally, the external structure should additionally suppress the exchange of gases through the metallic walls of the channels. In particular, the permeability for hydrogen of the precious metal alloys that are frequently used leads to bubble formation in the channels for many glasses and hence to significantly poorer glass quality.

The external structure used currently usually comprises ceramic casting compounds or fillings. Although these offer sufficient mechanical stabilization of the channel systems, permeation of hydrogen through the precious metal walls cannot be avoided. This is attributable firstly to the porous structure of the masses or fillings. Secondly, in the case of the ceramic masses used, there is usually further sintering at the high operating temperatures. The sintering shrinkage that occurs in the course of the sintering process additionally leads to formation of a gap between ceramic shell and metal channel. Exchange of gas with the environment is possible through this gap, which can additionally lead to bubble formation in the glass.

As well as sinter shrinkage, the different coefficients of thermal expansion of metal and ceramic at the high operating temperatures also lead to formation of a gap between channel and ceramic.

Although it is possible to suppress the exchange of gas by the controlled feeding of gases, for example of water vapour, into these gaps, the overall complexity for the construction and for the reliable operation of such systems is very high.

The gap formation and residual porosity of the ceramic additionally leads to a distinctly shortened lifetime of the precious metal components. Firstly, the precious metal reacts with the surrounding oxygen. The oxides that form evaporate, which reduces the wall thickness of the components. This leads to mechanical weakening of the components and hence to a shortened lifetime of the plant.

The available ceramic casting compounds, or ceramic refractory materials or structures produced therefrom, do not have failsafe running properties in the event of damage to the precious metal walls. The escaping glass dissolves constituents of the ceramic, which are then introduced into the glass to be processed as extraneous elements or ceramic particles.

One way of preventing permeation of gas through the precious metal channel and consequent bubble formation in the glass is that of vitrification of the precious metal channel. This involves placing the channel in a bath of molten glass. The glass closely adjoins the channel at all times here and hence prevents exchange of gas. In this way, however, it is not possible to embed vertical channel sections. Horizontal systems may be constructed in this way, in which case additional measures then have to be taken for mechanical stabilization of the channel. Moreover, the complexity for the vitrification in the commissioning of the channel is very high. The high external pressure resulting from the viscous glass on the outside of the channel wall can lead to buckling of the channel. A further disadvantage of this construction is additionally that a change in the type of glass in such a system is virtually impossible, since, for this purpose, the channel has to be completely emptied and then the precious metal components are pressed in immediately.

### SUMMARY

It is therefore an object of the invention to provide an apparatus for glass processing that does not have the disadvantages described above. A further object is that of providing a casting compound for production of a corresponding apparatus and a composite material.

The invention relates to a formulation comprising a base slip, quartz particles and particles of an admixture which especially comprises a multicomponent glass which is especially usable as casting compound.

The base slip comprises water as dispersion medium with a content between 30% and 50% by weight, preferably 35% and 45% by weight, most preferably 38% and 42% by weight, and ultrafine SiO₂ particles or ultrafine SiO₂ grains colloidally distributed therein with a proportion between 50% and 70% by weight, preferably 55% and 65% by weight, most preferably 58% and 62% by weight. The ultrafine SiO₂ particles are colloidally distributed in the dispersion medium and are also referred to hereinafter as colloidal SiO₂. In one embodiment, the ultrafine SiO₂ particles have a particle size distribution D₅₀ in the range from 1 to 3 μm, preferably 1 to 2 μm, and/or a particle size distribution D₉₀ of less than 5 μm, preferably less than 4 μm.

The formulation contains the base slip with a proportion between 18% and 36% by weight, preferably 20% and 30% by weight, quartz glass particles with a proportion between 40% and 70% by weight, preferably 50% and 60% by weight, and particles of the admixture comprising at least one multicomponent glass with a proportion between 10% and 40% by weight, preferably 20% and 30% by weight.

In one embodiment, the proportion of water in the formulation is 5% to 15% by weight. Corresponding water contents enable good flowability or castability of the formulation with as high a solids content as possible.

In an advantageous configuration of the invention, the quartz glass particles have a particle size distribution, where the quartz glass particles have a particle size distribution D50 in the range from 30 μm to 500 μm, preferably in the range from 63 μm to 250 μm, and/or a particle size distribution D₉₉ of less than 3.0 mm, preferably less than 2.0 mm and more preferably less than 1.0 mm.

A further admixture added to the formulation is a multicomponent glass. A multicomponent glass in the context of the invention is understood to mean a glass including not only SiO₂ but also at least one further glass-forming constituent.

In one embodiment, the particles of multicomponent glass have a particle size distribution with a median particle size D₅₀ in the range from 10 μm to 100 μm, preferably with a median particle size D₅₀ in the range from 15 to 40 μm. Corresponding particle size distributions ensure good processibility, especially good castability and homogenizability, of the formulation.

The invention relates to a formulation comprising water, fine SiO₂ particles, quartz glass particles and particles of a multicomponent glass. The formulation is especially usable as a casting compound. In one embodiment, the formulation contains a water content in the range from 5% to 18% by weight, preferably 7% to 16% by weight, a content of ultrafine SiO2 particles of 9% to 26% by weight, preferably 11% to 20% by weight, a content of multicomponent glass in the range from 10% to 40% by weight, preferably 20% to 30% by weight, and a content of quartz glass particles in the range from 40% to 70% by weight, preferably 50% and 60% by weight. Ultrafine SiO₂ particles or ultrafine SiO₂ grains are especially understood to mean SiO₂ particles having an average particle size in the range from 0.5 to 5 μm. The ultrafine SiO₂ particles in the formulation are especially in the form of SiO₂ particles colloidally distributed in water and are also referred to hereinafter as colloidal SiO₂.

In one embodiment, the ultrafine SiO₂ particles have a particle size distribution D₅₀ in the range from 1 to 3 μm and/or a particle size distribution D90 of less than 5 μm, preferably less than 4 μm.

The total proportion of water in the formulation is 10% to 20% by volume, preferably <15% by volume. In addition, the formulation includes, as a further constituent, 50% to 70% by volume of quartz glass particles and 15% to 35% by volume of particles of a multicomponent glass. A multicomponent glass is understood here to mean a glass including not only SiO₂ but also at least one further glass-forming constituent.

In one embodiment, the quartz glass particles have a particle size distribution D50 in the range from 150 μm to 1000 μm, preferably in the range from 200 to 700 μm, and/or a particle size distribution D₉₉ of less than 3.0 mm, preferably less than 1.0 mm and more preferably less than 800 μm.

Alternatively or additionally, the glass particles of the multicomponent glass have a particle size distribution D50 in the range from 40 to 150 μm, preferably in the range from 50 to 120 μm and more preferably in the range from 60 to 105 μm. Preferably, the particle size distribution D₉₉ is less than 100 μm, preferably less than 80 μm and more preferably less than 70

μm.

In one embodiment, the particle size distribution of the quartz glass particles and/or of the particles of the multicomponent glass is multimodal, preferably bimodal or trimodal. The ultrafine SiO₂ particles may especially have a monomodal particle size distribution.

In one development, the Andreassen equation of the size distribution of the particles of quartz glass, ultrafine SiO2 particles and multicomponent glass has a q value in the range from 0.1 to 0.3. In one embodiment, the q value is <0.3 or <0.25. The Andreassen model describes the possibility of being able to fill a space as densely as possible with spherical particles such that the remaining cavity becomes as small as possible but the mixture is nevertheless free-flowing. Through the use of particles having a broad particle size distribution under this condition, it is possible to fill a volume with a much higher fill level, i.e. with more particles per unit volume, than in the case of use of particles with a narrow particle distribution or even monodisperse particles. For instance, in the case of particles having a broad particle distribution, the smaller particles may be placed into the cavities that are formed between the larger particles and hence the space can be better exploited. The Andreassen model here defines an idealized particle size distribution with which the maximum fill level of a space with spherical particles can be achieved while maintaining flowability of the mixture:

$${Q}_{3} ( d ) = {( \frac{d}{D} )}^{q}$$

$$d ... particle size$$

$$D ... maximum particle size$$

$$q ... distribution coefficient$$

The particle size “d” is determined here as follows: the individual particles of a powder, irrespective of their real shape, are divided into various fractions with reference to the diameter of a sphere having their equivalent volume (volume-equivalent sphere diameter). In order to ascertain the particle distribution Q, the respective number of corresponding fractions within the powder is determined. In the Andreassen equation, the particle distribution Q₃ (d) is used, which is calculated from the volume of the respective fractions.

The q value gives the slope of the Andreassen equation in a log-log plot. The variation in the q value takes account of the variances in the real particles from the ideal model particles. These variances can occur, for example, via a shape of the particles that differs from an ideal sphere or interactions of the particles with one another or with the dispersion medium.

Particles that have a tendency to agglomerate owing to the interaction with the disperse phase show poorer rheological properties at low q values, i.e. would have a high fill level in the case of broad particle size distributions. This is the reason why a higher q value can be advantageous here. With a rising q value, however, the mixture becomes coarser and more difficult to process. Mixtures having a high fine content, by contrast, have a low q value.

The inventors have established that it is possible through the choice of q value to achieve higher fill levels in the casting compound. The Andreassen equation of glass particle size distribution in the formulation, in one embodiment, has a q value in the range from 0.1 to 0.3. Particularly high maximum volume fill levels are achieved in glass pastes, wherein the Andreassen equation has a q value in the range from 0.1 to 0.25.

The multicomponent glass may especially comprise a borosilicate glass, an aluminosilicate glass or a soda-lime glass. It is possible to adjust the properties of the composition in the later production process via the type, amount and particle size of the glasses added. For instance, the multicomponent glass added may especially influence properties such as coefficient of thermal expansion, thermal conductivity or softening temperature of the formulation, and also of the composite material producible from the formulation. A glass is preferably chosen here that has a maximum viscosity at the later operating temperature of the corresponding composite material. The glass preferably has a transition temperature T_{G} of <800° C., preferably <750° C. and more preferably <600° C., and/or a processing temperature TvA of more than 700° C., preferably more than 900° C. and more preferably more than 1150° C.

A selection criterion for the respective multicomponent glass may be the availability of the particle size distribution required. When the formulation is used for production of a composite material which is later used in a channel system, it has been found to be particularly advantageous when the multicomponent glass is compatible in terms of its composition with the glass which is produced or processed using the channel system. In a preferred embodiment, the multicomponent glass has the same or at least a similar chemical composition to the glass to be produced. For example, a multicomponent glass suitable for the production of borosilicate glasses is thus a Duran glass or a borosilicate glass 3.3, for example the applicant's type 8330 glass. For example, in the production of alkali-free glasses, a preferably alkali-free, at least low-alkali, glass is thus also accordingly used for the casting compound or the composite material. In the production of green glasses, i.e. crystallizable glasses, that can be converted to a glass-ceramic subsequent to the melting of the green glass or later by controlled thermal aftertreatment, identical glasses, or analogous glasses, green glasses if appropriate, are accordingly likewise added to the casting compound. An at least partial crystallization or ceramization of these glasses in the course of heating and/or in the operation of the channel system, for example, can have a further advantageous effect on the mechanical stability of the component. A casting compound comprising such a crystallizable multicomponent glass or at least partly crystallized multicomponent glass may also be used in the form of a material or composite material for shaped bodies, for example as a block, slab or a kind of strut for stabilization of structures in a glass melt tank and/or the corresponding hot shaping operation. In addition, use can also be effected in the melt and/or hot shaping operation locally and/or in temporally subsequent thermal processes, for example for shaping or ceramization.

In advantageous embodiments of the composite material and in an apparatus comprising this, the composition of the glass melt and the composition of the multicomponent glass are compatible, where the contents of the glass components of the multicomponent glass and of the glass melt preferably differ by not more than 10%, the contents of the glass components of the multicomponent glass and the glass melt having a proportion in the glass composition of <10% by weight differ from one another by a maximum factor of 2, and/or the composition of the multicomponent glass contains not more than 10% of components differing from the composition of the glass melt and more preferably has the same composition as the glass melt.

Also conceivable additionally is use of the casting compound or of a composite material formed therefrom in or during metal melting in a similar manner to that with regard to glass melting and further processing thereof.

A further aspect of the invention relates to a composite material, especially produced or producible with the formulation disclosed. The composite material comprises a sintered SiO2 matrix and glassy phases of a multicomponent glass dispersed therein. The proportion of the glassy phase is 18% to 42% by volume. The glass has a processing temperature TVA at which the glass has a viscosity of 10⁴ dPas of >700° C., preferably >900° C., preferably >1150° C., and a transition temperature of the glass T G of <800° C., preferably <750° C. and more preferably <600° C. The SiO₂ matrix is preferably largely crystalline, where the proportion of the glassy phases in the SiO₂ matrix is formed essentially by the multicomponent glass. In one embodiment, the proportion of the glassy phases is 10% to 40% by volume, preferably 18% to 25% by volume.

A further aspect of the invention relates to a process for producing an apparatus for transporting glass, especially a channel or feeder system composed of the above-described formulation. The process comprises at least the following steps a) to g):
a) providing the above-described formulation,
b) providing a ceramic mould,
b) providing a component made of a precious metal or refractory metal,
d) positioning the component provided in step c) in the mould provided in step b),
e) filling the mould with the casting compounds provided in step a), where the outer shell surfaces of the component provided in step c) are fully covered by the casting compound,
f) drying the mould filled in step e) by absorption of water through the walls of the ceramic mould provided in step b), g) heating the dried apparatus to a temperature in the range from 1100° C. to 1700° C., preferably in the range from 1100° C. to 1560° C.

The metallic component, especially in the form of a tube or a channel, is positioned in the ceramic mould provided in step b). The mould is especially a channel box with ceramic walls. The ceramic material of the mould here has good absorptivity for the water present in the casting compound. By virtue of the high absorptivity of the walls, a majority of the water is removed from the casting compound, such that a stable green body can be obtained. Materials for the mould have been found especially to be fine-grain ceramics with slight residual porosity, preferably sheets or mouldings based on slip-cast silica, since these can sinter efficiently together with the casting compound in step g). Likewise suitable are sheets based on ceramic fibres. These have the advantage that they are easy to process.

Once the metallic component has been placed in the mould in step d), the interstices or clear spaces in the mould are filled with the above-described casting compound in step e). The outer shell surfaces of a metallic component are covered here completely by the casting compound.

In the drying process, the water is absorbed rapidly by the ceramic walls of the mould, and the composition solidifies. The overall system is thus durable and ready for transport or for commissioning.

The commissioning is effected in step g) with the sintering of the casting compound in the mould. Step g) thus corresponds to the heating process on commissioning of the apparatus. In step g), the colloidal SiO₂ from the slip and the quartz glass particles are sintered at temperatures in the range from 1100° C. to 1700° C., preferably in the range from 1100° C. to 1560° , to give an SiO₂ matrix. A stable, ceramic silica framework is formed here. The ceramic framework is at least partly in the form of cristobalite. In this way, it is possible to achieve high mechanical stability. In one embodiment, 60% to 90% by volume, preferably 75% to 82% by volume, of the Si02 matrix is in the form of cristobalite.

The ceramic framework has pores that are filled with the multicomponent glass. The multicomponent glass in the resultant composite material forms the glass phase. The glass phase is not distributed homogeneously throughout the Si0 2 matrix here, but rather is enriched at the interface between composite material and metallic component. A glassy layer is thus formed at the outer shell surface of the component provided in step c), which wets the outer shell surface of the component.

This can be explained in that the high thermal conductivity of the metallic channel material results in softening of the multicomponent glass, preferably at the outer shell surfaces of the channel, and tight enclosure of the latter. A film of a tough, viscous mass is thus formed at the surface of the metal components. The composite material thus has a higher proportion of glassy phase in at least an outer region than in an inner region.

Surprisingly, the glass film is completely closed and hence prevents gas exchange, especially permeation of hydrogen. The composite material according to the invention thus enables the construction of a dimensionally stable and gastight external structure. The composite material here, or the external structure formed thereby, surprisingly has the respective advantages of ceramic and glass-based external structures.

However, it is also possible in step g) to heat to temperatures below 1100° C. No cristobalite transformation takes place at these temperatures, such that the composite material is formed from a quartz glass matrix interspersed with glass phases of the multicomponent glass. Corresponding composite materials may be used, for example, in the production of optical glasses, which are produced generally at temperatures below 1100° C. In that case too, the addition of glass in the casting compound is preferably likewise selected to be effectively of the same type, i.e. to be at least similar, in turn, in terms of its composition to the or a glass to be melted or to be produced.

Step g) may take place during commissioning directly in or at the production assembly in the installed state of the channel, for example, or else alternatively may be undertaken wholly or partly beforehand, i.e. prior to incorporation and commissioning in a separate thermal treatment step.

At temperatures above the softening point of the multicomponent glass, the glassy component of the composite material has a viscoelastic characteristic. In this way, in a corresponding apparatus comprising the composite material as stabilizing external material and a metallic component, it is possible to dissipate stresses that occur, for example, as a result of the large differences in coefficients of thermal expansion of metal and sintered composite. In particular, the glassy film at the outer shell surface of the metal component can compensate for this difference in expansion.

By virtue of the cristobalite structure of the ceramic matrix, the composite material remains stable even at the high processing temperatures in spite of this behaviour. It not only imparts high mechanical stability to the composite material and hence also to the apparatus, but also prevents the glass film from flowing away. By virtue of this stabilization of the glass film, it is thus also possible with the composite material according to the invention to create apparatuses with vertical elements.

The inventors have additionally found that, surprisingly, the porous cristobalite structure, in the event of damage to the metallic component, can additionally also absorb the production glass that escapes from the leak in the metallic component. Thus, the leak is closed automatically and the production process can be continued without any adverse effect on the quality of the glass produced.

A further advantage of the composite material disclosed over pure SiO₂ materials is that the apparatuses equipped with the composite material can also be cooled down to temperatures below 275° C. without being damaged. These apparatuses, for example channels, thus need not be heated further in the event of a production shutdown. By contrast, apparatuses with a pure SiO₂ material in the external structure have to be heated to temperatures above 275° C. even in the event of a production shutdown. The reason for this is the property of cristobalite to be transformed to a different crystal modification in the event of cooling to temperatures below 275° C. This process, referred to as “cristobalite jump”, is associated with a very significant decrease in volume. This can lead to cracking in the external structure.

The disclosed composite material is viscoelastic owing to the glass phase. Thus, the glass phase reduces the effects of the above-described phase jump and assures the integrity of the composite material even in the case of a distinct decrease in volume.

A further aspect of the invention is that of providing an apparatus for glass processing, especially in the form of a channel or feeder system. A corresponding apparatus here comprises a composite material containing a sintered, largely crystalline SiO₂ matrix with glassy phases of a multicomponent glass as the external structure. A metallic component, especially in the form of a channel or a pipe, has been sunk into this external structure, where the outer shell surface of the metallic component has been fully wetted by the composite material and form-fittingly bonded thereto, and a glassy layer has been formed at the interface between composite body and metallic component. Advantageous metals have been found to be, in particular, precious metals, preferably platinum, gold, iridium, rhodium or alloys thereof. Alternatively or additionally, it is also possible to use a refractory metal, especially molybdenum, tungsten or alloys thereof.

The composite material comprises a sintered SiO₂ matrix containing cristobalite, and glassy phases of a multicomponent glass dispersed in the SiO₂ matrix, where the proportion of the glassy phase is 18% to 42% by volume and the processing temperature T_{VA} of the glass is >700° C. and/or the transition temperature of the glass T_{G} is <800° C., where the sintered SiO₂ matrix contains cristobalite.

The outer shell surfaces of the metallic component are completely covered by the composite material. The glassy phases are enriched here in the region of the metallic component. Thus, the outer shell surfaces of the metallic component are covered by a thin glass film.

In one embodiment, the apparatus is part of a channel or feeder system for transportation of liquid glass.

### BRIEF DESCRIPTION OF THE DRAWINGS

FIG. 1 is a schematic diagram of the casting compound;

FIG. 2 is a schematic diagram of a detail from the composite material;

FIG. 3 is a schematic diagram of an apparatus for transporting glass; and

FIG. 4 is an enlarged detail of the apparatus shown in FIG. 3.

### DETAILED DESCRIPTION

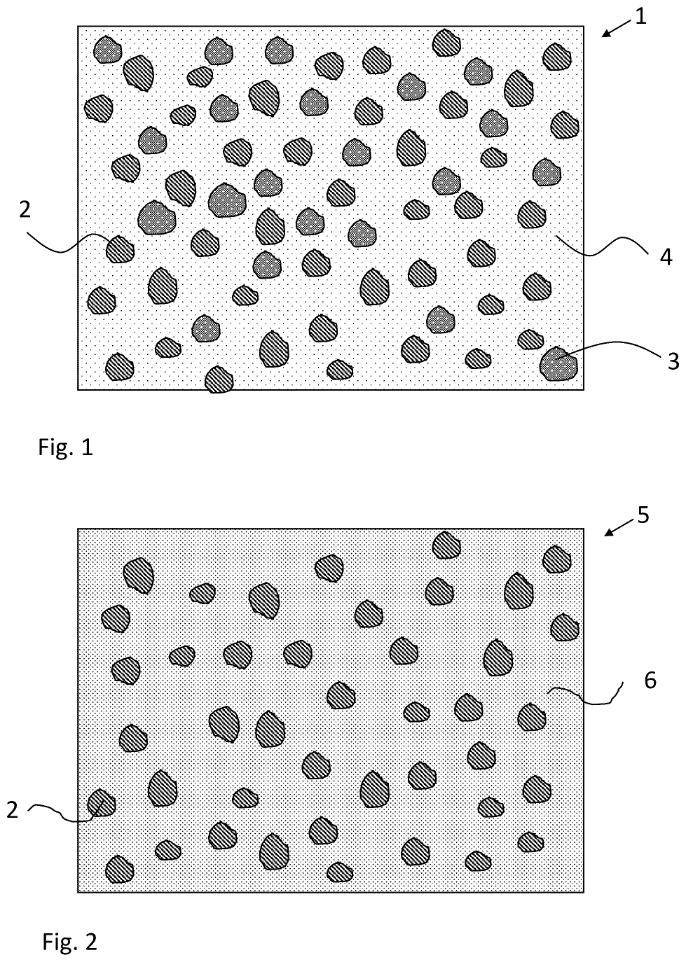

FIG. 1 shows the schematic diagram of a casting compound 1 in a first working example. The formulation contains the base slip with a proportion between 18% and 36% by weight, quartz glass particles with a proportion between 40% and 70% by weight, and particles of the admixture comprising at least one multicomponent glass with a proportion between 10% and 40% by weight.

The base slip comprises water as dispersion medium between 30% and 50% by weight, and ultrafine SiO₂ particles or ultrafine SiO₂ grains colloidally distributed therein with a proportion between 50% and 70% by weight, preferably 55 and 65% by weight, most preferably 58% and 62% by weight.

The total proportion of water in the formulation is 10% to 20% by weight. In the embodiment shown in FIG. 1 multicomponent glass 2 used is a borosilicate glass. The median particle size D₅₀ of the multicomponent glass 2 in the working example shown in FIG. 1 is in the range from 60 to 105 μm. The quartz glass particles have a median particle size D₅₀ in the range from 200 μm to 700 μm. The particle size distributions of multicomponent glass 2 and quartz glass 3 are preferably chosen such that the mixture can be described by an Andreassen equation with a q value of less than 0.3. The multicomponent glass 2 has a glass transition temperature T_{G} <800° C., preferably <750° C., more preferably <600° C., and/or a processing temperature TVA >700° C., preferably >900° C. and more preferably >1150° C. In one embodiment, the multicomponent glass 2 has a glass transition temperature T_{G} in the range from 630 to 800° C.

FIG. 2 shows a schematic of the composite material 5 produced by sintering the formulation shown in FIG. 1. The composite material 5 here may have pores (not shown in FIG. 2). The sintering transformed the quartz glass particles 3 and the colloidally distributed SiO₂ 4 to a quartz matrix 6. The quartz matrix 6 is at least partly crystalline and has a cristobalite structure as crystal structure. The proportion of cristobalite in the quartz matrix 6 in the working example shown in FIG. 2 is 75% to 82% by volume. Glass phases 2 are dispersed in the quartz matrix 6. The glass phases 2 are accommodated by the quartz matrix 6 and fill the pores of the quartz matrix 6 here. The softening point of the multicomponent glass 2 here is preferably below the temperature at which the composite material 5 is used, for example when the composite material 5 is used in an apparatus for glass melting. By virtue of the glass phases 2 that are thus viscous in a corresponding use, the composite material 5 has viscoelastic properties at operating temperature. When the composite material 5 is used in apparatuses comprising metallic components, these viscoelastic properties allow effective dissipation of mechanical stresses that arise from the different coefficients of thermal expansion of the materials used.

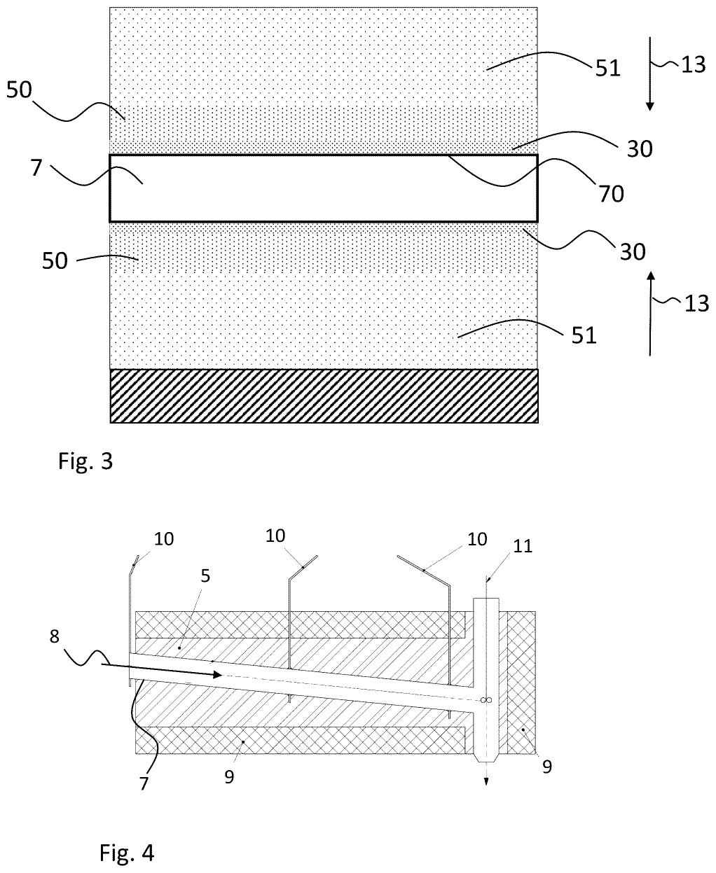

If the composite material 5 is produced by sintering the casting compound 1 on contact with a component having high thermal conductivity, for example a metallic component, the composite material 5 may have an inhomogeneous distribution of the glass phases 2. This is shown schematically in FIG. 3. FIG. 3 here shows a cross section through a composite material 5 in which a metallic component 7 is embedded. The metallic component 7 in the working example shown in FIG. 3 is a stainless steel tube having the outer shell surfaces 70. The outer shell surfaces 70 are fully surrounded by the composite material 5. The composite material 5 here has regions having different contents of glass phases. The different content of glass phases is represented by the individual regions 51, 50 and 30. The composite material here, in the regions that are in contact with the shell surfaces 70 of the metal tube 7, has a higher content of glass phases than the outer regions 51. Thus, the working example shown in FIG. 3 has a gradient with regard to the content of glass phases. This is symbolized in FIG. 3 by the arrows 13, where the arrows 13 point in the direction of the higher glass phase content. At the interface of the composite material 5 with the outer shell surfaces 70 of the metal tube 7, a closed glass film 30 is formed. This is adjoined by regions 50 of the composite material 5 having an elevated glass phase concentration compared to the regions 51. The regions 50 and 51 may have a common interface. It is likewise possible that the two regions 50, 51 merge continuously into one another.

FIG. 4 shows a schematic diagram of an apparatus 12 in the form of a channel or feeder system for transportation of glass melts using a working example. The apparatus 12 comprises the composite material 5, and a metal tube 7 embedded in the composite material 5. The flow of glass through the metal tube 7 is represented by the arrow 8. The composite material 5 forms the supporting structure of the apparatus 12. By virtue of its high mechanical stability of the composite material 5, it is also possible to achieve constructions with vertical sections. It is additionally possible for further elements such as measuring or heating elements to be accommodated in the composite material 5. In the working example shown in FIG. 4, the composite material 5 also accommodates the temperature sensors 10 and a stirred crucible 11. The apparatus 12, for improvement of thermal insulation, additionally has the insulation layers 9 that surround the outsides of the composite material.

What is claimed is:

1. A formulation for a casting compound, comprising:
a base slip with a proportion between 18% and 36% by weight;
quartz glass particles with a proportion between 40% and 70% by weight; and
additional particles of an admixture comprising at least one multicomponent glass with a proportion between 10% and 40% by weight, wherein the base slip comprises water as dispersion medium and ultrafine SiO₂ particles, the water having a content between 30% and 50% by weight, the ultrafine SiO₂ particles being colloidally distributed in the dispersion medium and having a content between 50% and 70% by weight.

2. The formulation of claim 1, wherein the quartz glass particles have a particle size distribution D₅₀ in a range from 150 μm to 1000 μm and/or a particle size distribution D₉₉ of less than 3000 μm.

3. The formulation of claim 2, wherein the particle size distribution D₅₀ is in a range from 200 μm to 700 μm and/or the particle size distribution D₉₉ is less than 800 μm.

4. The formulation of claim 1, wherein the quartz glass particles and/or the additional particles have a particle size distribution selected from a group consisting of multimodal, bimodal, and trimodal.

5. The formulation of claim 1, wherein the additional particles have a particle size distribution D₅₀ in a range from 40 to 150 μm and/or a particle size distribution D₉₉ of less than 100 μm.

6. The formulation of claim 5, wherein the particle size distribution D₅₀ in a range from 60 to 105 μm and/or a particle size distribution D₉₉ of less than 70 μm.

7. The formulation of claim 1, wherein the at least one multicomponent glass comprises a glass selected from a group consisting of borosilicate glass, an aluminosilicate glass, and soda-lime glass.

8. The formulation of claim 1, wherein the glass particles have a size distribution that satisfies an Andreassen equation:
$${Q}_{3} ( d ) = {( \frac{d}{D} )}^{q}$$
$$d ... particle size$$
$$D ... maximum particle size$$
$$q ... distribution coefficient$$
with a distribution coefficient q<0.3.

9. The formulation of claim 1, wherein the at least one multicomponent glass has a transition temperature Tg<800° C. and/or a processing temperature TVA >700° C.

10. The formulation of claim 1, wherein the at least one multicomponent glass has a transition temperature Tg<600° C. and/or a processing temperature TVA >1150° C.

11. The formulation of claim 1, wherein the formulation is rheopectic at room temperature.

12. A composite material, comprising
a sintered SiO₂ matrix and a glassy phase of a multicomponent glass dispersed therein,
wherein the glassy phase has a proportion of 18% to 42% by volume,
a processing temperature T_{VA} at which glass of the glassy phase has a viscosity of 10⁴ dPas is >700° C.; and
a transition temperature of the glass T_{G} is <800° C.

13. The composite material of claim 12, wherein the processing temperature T_{VA} of the glass at which the glass has a viscosity of 10⁴ dPas is 22 1150° C. and the transition temperature of the glass T_{G} is <600° C.

14. The composite material of claim 12, wherein the SiO₂ matrix is largely crystalline and the proportion of glassy phases in the SiO₂ matrix is formed essentially by the multicomponent glass, wherein the proportion is 10% to 40% by volume.

15. The composite material of claim 14, wherein the proportion is 18% to 25% by volume.

16. The composite material of claim 12, wherein the sintered SiO₂ matrix comprises cristobalite of at least 60% by volume.

17. The composite material of claim 12, wherein the sintered SiO₂ matrix comprises cristobalite of at least 75% by volume.

18. The composite material of claim 12, wherein the multicomponent glass, prior to sintering, comprises glass particles with a particle size distribution D₅₀ in a range from 40 to 150 μm and/or a particle size distribution D₉₉ of less than 100 μm.

19. The composite material of claim 12, further comprising an outer region and an inner region, wherein the proportion of the glass phase in the outer region is higher than in the inner region.

20. The composite material of claim 12, further comprising viscoelastic properties at temperatures above a softening temperature of the multicomponent glass.
